(19) United States
(12) Patent Application Publication
(10) Pub. No.: US 2025/0267161 A1
(43) Pub. Date: Aug. 21, 2025

(54) SYSTEM AND METHOD FOR VERIFYING AUTHENTICITY OF INBOUND EMAILS WITHIN AN ORGANIZATION

(71) Applicant: Paubox, Inc., San Francisco, CA (US)

(72) Inventor: Hoala Greevy, San Francisco, CA (US)

(21) Appl. No.: 19/085,339

(22) Filed: Mar. 20, 2025

Related U.S. Application Data
(63) Continuation-in-part of application No. 17/886,058, filed on Aug. 11, 2022.
(60) Provisional application No. 63/231,845, filed on Aug. 11, 2021.

(51) Int. Cl. H04L 9/40

(52) U.S. Cl. CPC H04L 63/1425; H04L 63/1441

(57) ABSTRACT

One variation of a method includes: intercepting an inbound email received from a sender at an inbound email address and addressed to a recipient within an organization; accessing a keyword list including a set of keywords associated with inauthentic email attempts; and, in response to identifying a first word, in a set of words contained in the inbound email, in the set of keywords, scanning the first inbound email for presence of external content linked to the first inbound email. In response to detecting a link to an external document within the first inbound email, the method further includes: accessing a whitelist including a set of verified email addresses associated with authentic email attempts within the organization; and, in response to the set of verified email addresses omitting the inbound email address, withholding transmission of the inbound email to the target recipient and flagging the inbound email for authentication.

### CROSS-REFERENCE TO RELATED APPLICATIONS

This application is a continuation-in-part of U.S. patent application Ser. No. 17/886,058, filed on 11 Aug. 2022, which claims the benefit of U.S. Provisional Application No. 63/231,845, filed on 11 Aug. 2021, each of which is incorporated in its entirety by this reference.

### TECHNICAL FIELD

This invention relates generally to the field of email communications and more specifically to a new and useful method for verifying authenticity of inbound emails in the field of email communications.

### BRIEF DESCRIPTION OF THE FIGURES

FIGS. 1A and 1B are flowchart representations of a method;

FIGS. 2A, 2B, and 2C are flowchart representations of one variation of the method;

FIG. 3 is a flowchart representation of one variation of the method;

FIG. 4 is a flowchart representation of one variation of the method;

FIG. 5 is a flowchart representation of one variation of the method;

FIGS. 6A and 6B are flowchart representations of one variation of the method;

FIGS. 7A and 7B are flowchart representations of one variation of the method; and

FIG. 8 is a flowchart representation of one variation of the method.

### DESCRIPTION OF THE EMBODIMENTS

The following description of embodiments of the invention is not intended to limit the invention to these embodiments but rather to enable a person skilled in the art to make and use this invention. Variations, configurations, implementations, example implementations, and examples described herein are optional and are not exclusive to the variations, configurations, implementations, example implementations, and examples they describe. The invention described herein can include any and all permutations of these variations, configurations, implementations, example implementations, and examples.

### 1. METHOD

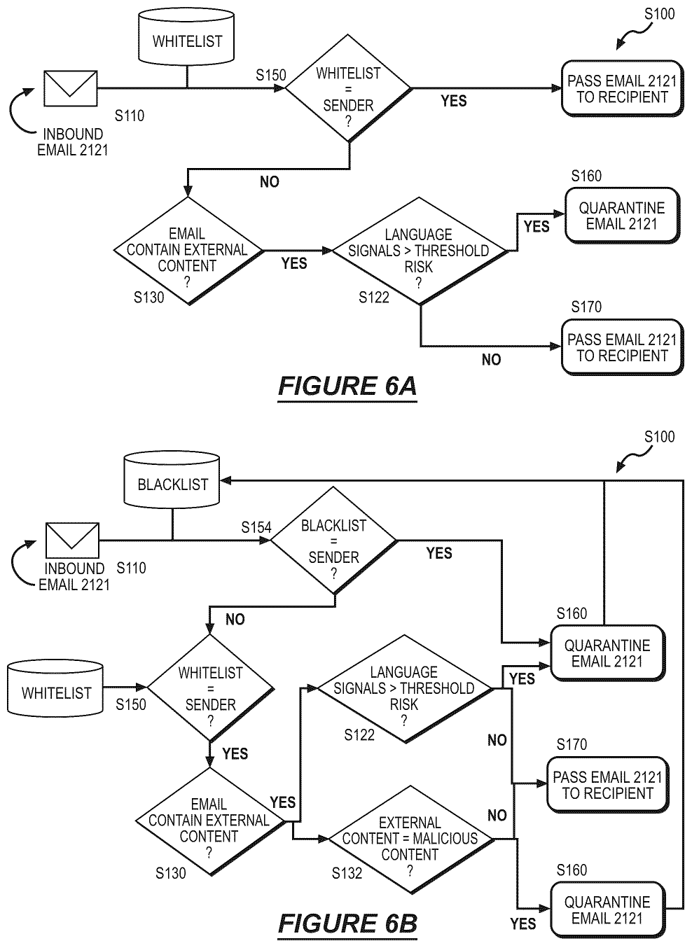

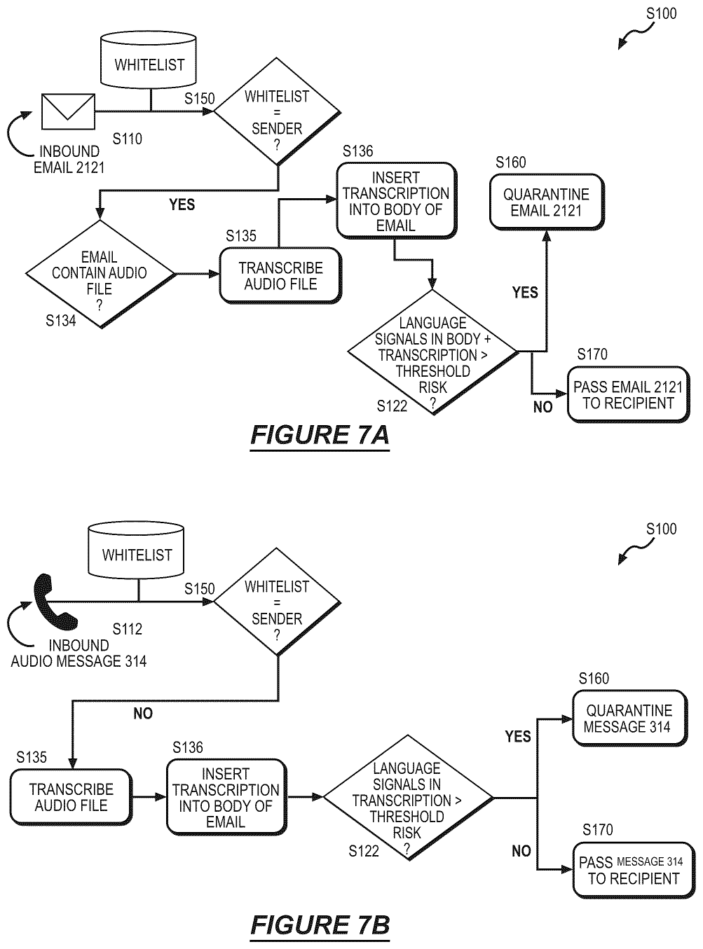

As shown in FIGS. 6A-6B and 7A-7B, a method S100 includes: intercepting a first inbound email received from a first sender at a first inbound email address and addressed to a first recipient associated with an organization in Block S110; and accessing a whitelist associated with the organization and including a set of verified email addresses associated with authentic email attempts within the organization in Block S150. The method S100 further includes, in response to the set of verified email addresses omitting the first inbound email address, scanning the first inbound email for presence of external content linked to the first inbound email in Block S130 and, in response to detecting a first link to a first external document within the first inbound email: scanning a body of the first inbound email for language signals in a set of language signals associated with fraudulent email attempts in Block S122; and, in response to detecting a correlation between a first sequence of words, in the body of the first inbound email, with a first language signal in the set of language signals, withholding transmission of the first inbound email to the first recipient in Block S160.

### 1.1 Variation: Risk Scoring

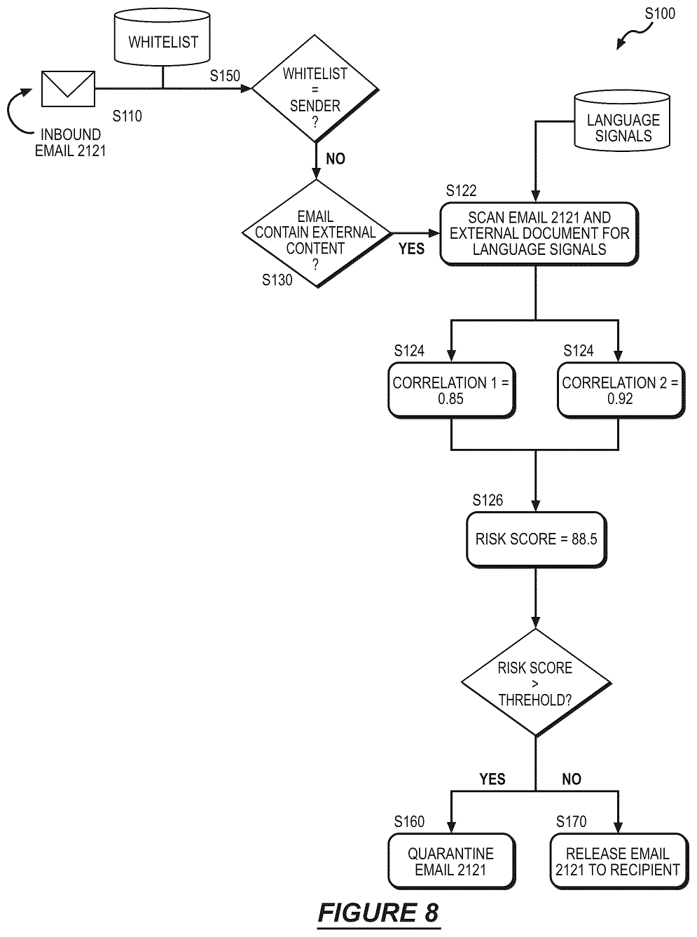

As shown in FIG. 8, one variation of the method S100 includes: intercepting a first inbound email received from a first sender at a first inbound email address and addressed to a first recipient; scanning a body of the first inbound email for language signals in a set of language signals; detecting a first correlation between a first sequence of words, in the body of the first inbound email, with a first language signal in the set of language signals; detecting a second correlation between a second sequence of words, in the body of the first inbound email, with a second language signal in the set of language signals; and calculating a risk score based on the first correlation and the second correlation. This variation of the method S100 further includes, in response to the risk score exceeding a threshold risk score: accessing a whitelist associated with the organization and including a set of verified email addresses associated with authentic email attempts within the organization; and, in response to the set of verified email addresses omitting the first inbound email address, withholding transmission of the first inbound email to the first recipient.

In one variation, the method S100 further includes: intercepting a second inbound email received from a second sender at a second inbound email address and addressed to a second recipient; scanning a second body of the second inbound email for language signals in the set of language signals; detecting a third correlation between a third sequence of words, in the second body of the second inbound email, with a third language signal in the set of language signals; detecting a fourth correlation between a fourth sequence of words, in the second body of the second inbound email, with a fourth language signal in the set of language signals; and calculating a second risk score based on the third correlation and the fourth correlation. This variation of the method S100 further includes, in response to the second risk score exceeding the threshold risk score: accessing the whitelist associated with the organization and including the set of verified email addresses associated with authentic email attempts within the organization; and, in response to the set of verified email addresses including the second inbound email address, releasing the second inbound email to the second recipient.

In one variation, the method S100 further includes: intercepting a second inbound email received from a second sender at a second inbound email address and addressed to a second recipient; scanning a second body of the second inbound email for language signals in the set of language signals; detecting a third correlation between a third sequence of words, in the second body of the second inbound email, with a third language signal in the set of language signals; detecting a fourth correlation between a fourth sequence of words, in the second body of the second inbound email, with a fourth language signal in the set of language signals; calculating a second risk score based on the third correlation and the fourth correlation; and, in response to the second risk score falling below the threshold risk score, releasing the second inbound email to the second recipient.

### 1.2 Variation: Keyword Search

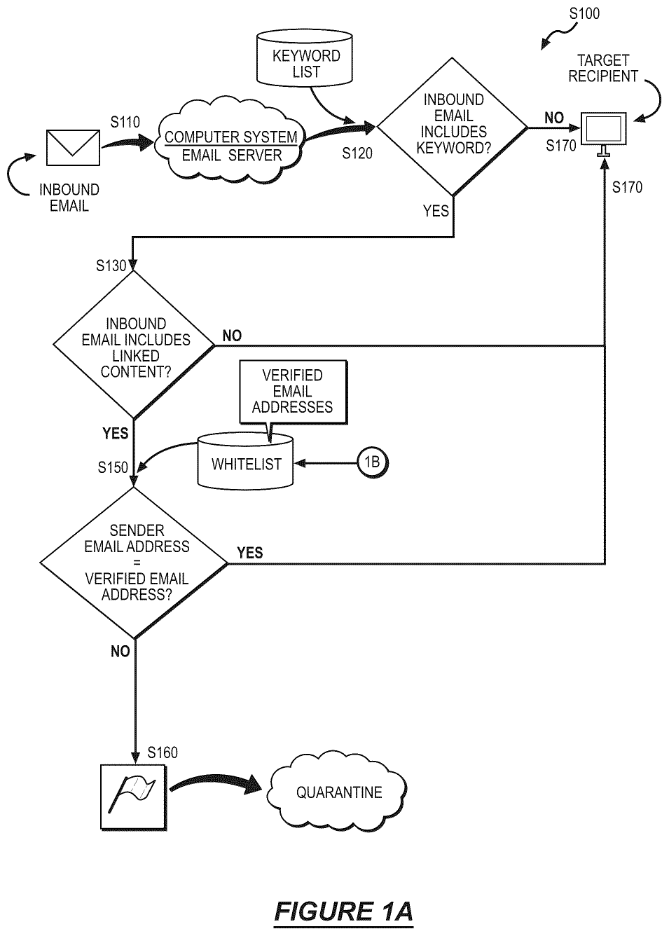

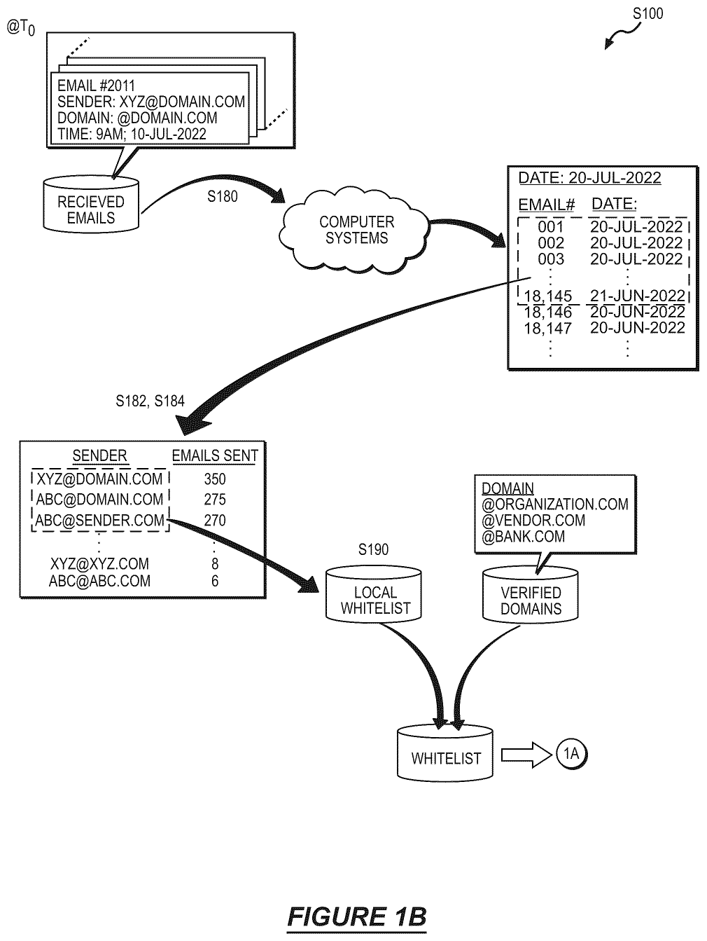

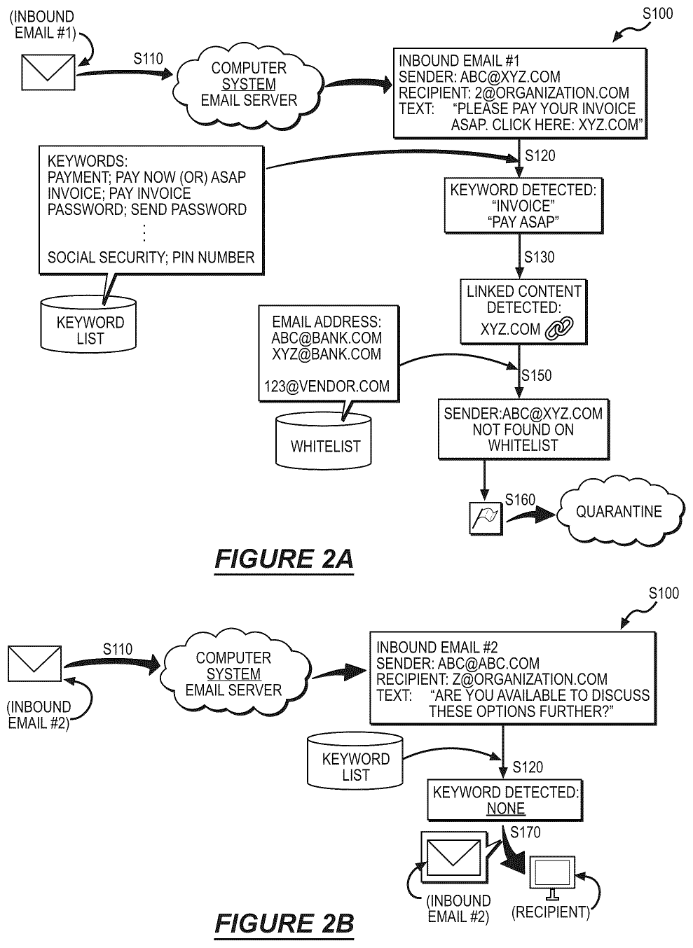

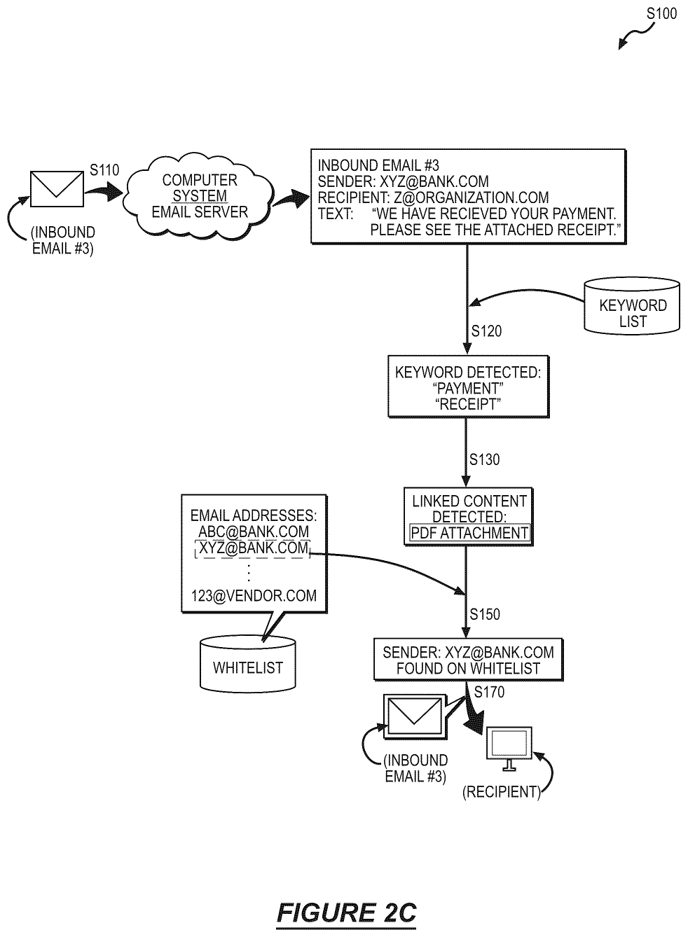

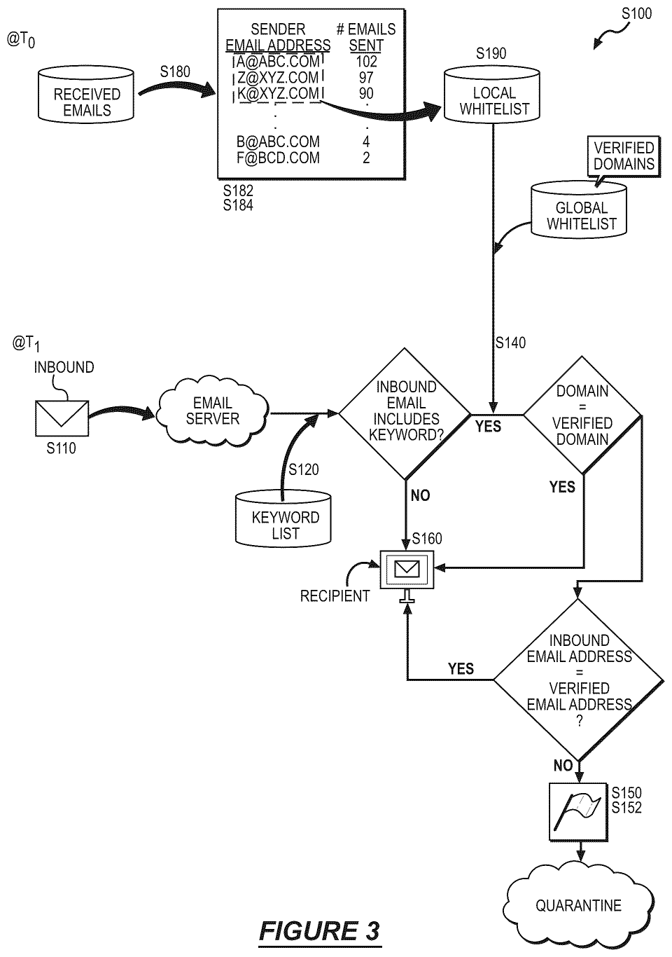

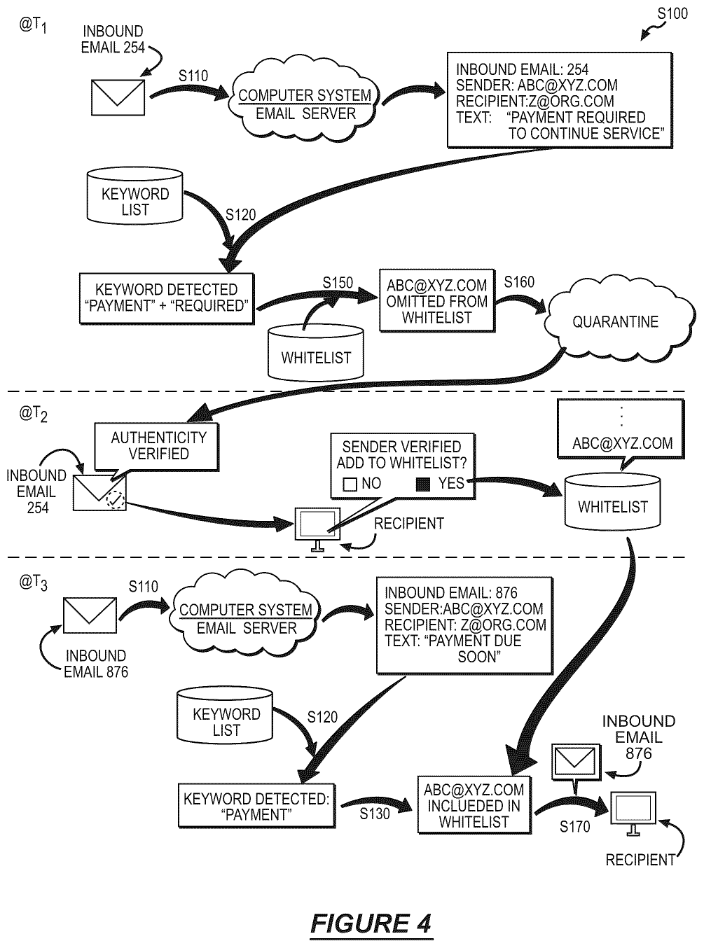

As shown in FIGS. 1A, 1B, 2A-2C, and 3-5, one variation of the method S100 includes: intercepting an inbound email received from a sender at an inbound email address and addressed to a target recipient within an organization in Block S110; accessing a keyword list including a set of keywords associated with inauthentic email attempts and comparing a set of words contained in the inbound email to the set of keywords in Block S120; and, in response to identifying a first word, in the set of words contained in the inbound email, in the set of keywords, scanning the first inbound email for presence of external content linked to the first inbound email in Block S130. In response to detecting a link to an external document (e.g., a webpage, a PDF attachment) within the first inbound email, the method S100 further includes: accessing a whitelist associated with the organization and including a set of verified email addresses associated with authentic email attempts within the organization and comparing the inbound email address to the set of verified email addresses contained in the whitelist in Block S150; and, in response to the set of verified email addresses omitting the inbound email address, withholding transmission of the inbound email to the target recipient and flagging the inbound email for authentication in Block S160.

### 2. APPLICATIONS

Generally, Blocks of the method S100 can be executed by a computer system (e.g., an email server) to verify authenticity of an inbound email before passing the inbound email to its designated recipient in order to detect and suppress spoofing attempts. In particular, the computer system can leverage detection of language signals in an email commonly associated with inauthentic email attempts (e.g., phishing attempts, spoofing attempts) indicating the inbound email as an inauthentic email attempt, and accordingly quarantine such an inauthentic email attempt.

More specifically, in one implementation, the computer system can: intercept an email inbound to an organization; scan a body of the inbound email for language, tonal, and security signals; scan email metadata for indicators of compromised content (e.g., virus, attachments, external links); identify presence (or absence) of historical and/or trusted communications between the sender and recipient of the email (e.g., based on a whitelist, based on a blacklist); calculate a risk that the email represents a fraudulent email attempt (e.g., attempted security breach, spoofing attempt) to the recipient or organization based on these signals; and, based on the risk exceeding a threshold, quarantine the email to prevent the recipient from receiving the fraudulent email attempt. Additionally or alternatively, the computer system can release an inbound email to a recipient in response to the risk falling below a risk score, indicating an authentic email attempt.

Accordingly, the computer system can, thereby, enable security personnel associated with the organization to review flagged inbound emails and release the email to the target recipient and/or reinforce interpretation of these language signals as indicative of fraudulent email attempts.

The system can therefore: reduce a quantity of fraudulent emails sent to recipients within an organization; minimize a likelihood of negative consequences—such as financial loss, a security breach, or identity theft—triggered by undetected phishing attempts; increase trust and confidence of recipients (e.g., employees) of emails, and therefore enable employees to engage with or act on contents contained in emails more efficiently; and minimize latency between sending of an email from a verified email address from a verified domain for this organization by automatically releasing emails sent by verified senders and/or emails representing a risk below a threshold risk.

In one example, the computer system can execute a sequence of security checks, or a subset of security checks in the sequence of security checks, in series based on content detected within an inbound email. In particular, in this example, the computer system can access a whitelist including a set of verified email addresses, such as populated by an administrator associated with the organization. The computer system can then scan the whitelist (or the set of verified email addresses) for a sender email address associated with the inbound email and, in response to the whitelist omitting the sender email address, identify the sender as unknown and proceed to a second security check.

The computer system can then scan the inbound email for presence of external content (e.g., hyperlinks, attachments) linked to the inbound email, which may indicate presence of malicious content and/or corrupted data attached to the inbound email that may release a virus or otherwise corrupt a target recipient's email account, device, etc.

In response to detecting presence of external content linked to the inbound email (e.g., indicating a high-risk inbound email), the computer system can proceed to a third security check, such as scanning the inbound email for presence of language signals, in a set of language signals, associated with fraudulent email attempts. Then, in response to detecting language signals, in the set of language signals, within the body of (and/or in an attachment associated with) the inbound email, the computer system can classify the inbound email as an inauthentic email attempt and withhold transmission of the inbound email, such as by quarantining the inbound email or flagging the inbound email for review by an administrator.

Therefore, in this example, the computer system can increase security and trust of inbound emails reaching a target recipient's inbox while minimizing a computational load of security checks required for a particular inbound email.

### 2.1 Variation: Keyword Search

In one variation, the computer system can leverage identification of keywords—commonly found in inauthentic email attempts—contained in inbound emails to employees within an organization to identify and investigate inbound emails that may be inauthentic. The system can then leverage additional sender information (e.g., email address) to determine whether these possible inauthentic email attempts are sent from trusted email senders (or “verified senders”) for this organization or from unknown or infrequent email senders for this organization.

For example, a phisher may: leverage an organization directory to identify email addresses of employees within an organization; and deliver an email to an employee or associate of the organization with an urgent request, such as to provide organization login information or complete a purchase on behalf of the phisher. Because the email includes an urgent request, the recipient may also be prompted to act quickly and thus allocate less time to considering authenticity of the request, which may result in the recipient completing the action requested in this email on behalf of the phisher.

Therefore, the computer system can execute Blocks of the method S100 to: intercept inbound emails sent to employees within an organization; scan contents of these inbound emails for keywords or content associated with inauthentic emails (i.e., spoofing attempts); authenticate inbound emails—containing these keywords—sent from verified email senders at this organization; and quarantine inbound emails—containing these keywords-sent from unverified senders at this organization for further investigation (e.g., by an email administrator).

### 3. EXAMPLE

In one example, during a setup period—such as at an end or beginning of a work week—the computer system can access a corpus of inbound emails received by a set of employees within an organization during a preceding period of time. Then, for each inbound email in the set of inbound emails, the computer system can: identify a sender email address corresponding to a sender of the inbound email; access a sender email address list corresponding to inbound emails received during the preceding period of time; and, in response to the sender email address list excluding the sender email address, append the sender email address list with the sender email address. However, in response to the sender email address list including the sender email address, the system can: update a count corresponding to a number of inbound emails received from the sender email address during the preceding time period.

Then, the system can: identify a subset of sender email addresses, in the list of sender email addresses, associated with a higher count than each other sender email address excluded from the subset of sender email addresses; label the subset of sender email addresses as verified email addresses; and populate an organization whitelist with these verified email addresses.

The computer system can also load a keyword list (e.g., a predefined and/or manually-updated keyword list) including a set of words, phrases, and/or combinations of words that may be indicative of a spoofing attempt. In particular, the keyword list can include: financial terms (e.g., “transaction,” “check,” “money order,” “transfer,” “payment”, “credit card”); security-related terms (e.g., “password,” “username,” “update login”); identity-related terms (e.g., “social security,” “full name,” “address”); etc.

Later, during a live period succeeding the setup period, upon receiving an email from a sender (e.g., outside of the organization), the computer system can scan the email to determine whether the email (e.g., a subject and/or body of the email) includes any words or phrases contained in the keyword list. Then, if the email includes a particular word matched to a keyword, in the keyword list, the computer system can: identify a sender email address—including a username and a domain—corresponding to the sender of the email; access a global whitelist including a set of verified domains associated with authentic email attempts (e.g., domains corresponding to organizations associated with financial services); and compare the domain of the sender email address to the set of verified domains. If the domain of the sender email address matches one of the verified domains in the global whitelist, the computer system can deliver (or “release”) the email to a designated recipient specified by the inbound email. However, if the domain of the sender email address does not match any of the verified domains in the global whitelist, the computer system can implement additional steps to continue verification of the email.

In particular, the computer system can: access the organization whitelist; and compare the sender email address to sender email addresses (or “verified sender email addresses”) contained in the organization whitelist. If the sender email address matches one of the verified sender email addresses in the organization whitelist, the computer system can deliver (or “release”) the email to a designated recipient specified by the inbound email. However, if the sender email address does not match a verified email address in the organization whitelist, the computer system can: withhold the email from the designated recipient; quarantine the email, such as by diverting the email to a quarantine database; and notify an email administrator of the quarantined email. The email administrator may further investigate validity of the email and then determine whether to deliver the quarantined email to the recipient.

In this example, in order to notify the email administrator of the quarantined email, the computer system can: generate a notification email containing a hyperlink to access the quarantine database within a web portal; and deliver the notification email to the email administrator. Upon receiving the notification email, the email administrator may: select the hyperlink to automatically open a web browser and to navigate to the web portal containing the quarantine database; view the quarantined email to determine the validity of the email; and select whether to deliver the quarantined email to the recipient or discard the quarantined email based on results of her investigation. Additionally and/or alternatively, the computer system can: populate a notification email with contents and sender data of the inbound email and a hyperlink to release the email into the notification email; deliver the notification email to the email administrator; and automatically deliver the email to the recipient upon selection of this hyperlink by the email administrator (e.g., “one-click” release). Yet alternatively, the computer system can generate an alert—linked to this quarantined email—and insert this alert into a security alert feed at an ISOC affiliated with the organization.

In this example, the system can leverage the organization whitelist during the live period to authenticate inbound emails sent from verified senders and quarantine inbound emails-including keywords contained in the keyword list-sent from unverified senders excluded from this organization whitelist. The system can then initiate a subsequent setup period, succeeding the live period, to generate an up-to-date organization whitelist for this organization for a subsequent live period. The system can, therefore, regularly update the organization whitelist.

### 4. ONBOARDING

The computer system interfaces with employees, associates, or other representatives of an organization to access and aggregate email data (e.g., sender email addresses of all inbound emails, quantity of inbound emails sent from each sender, sender email addresses associated with read and/or unread emails) of these employees. The computer system can then leverage this email data to investigate validity of emails containing content that may be more likely to indicate a spoofing attempt.

In one implementation, the system can collect email data from employees within the organization during an initial setup period. For example, the system can: collect email data corresponding to inbound emails received by employees within the organization during an initial setup period of a particular duration (e.g., one day, one week, one month, one year); and leverage this email data to populate a local whitelist for investigating validity of inbound emails sent to employees within the organization during a live period succeeding the setup period.

Additionally and/or alternatively, in another implementation, the system can regularly collect email data from within an organization. In particular, in this implementation, the system can access email data of employees within the organization at a fixed frequency (e.g., weekly, monthly) to generate an up-to-date organization whitelist. For example, the system can schedule a recurring setup period each week (e.g., Friday evening, Sunday evening, Monday morning). During this setup period, the system can: access email data of inbound emails received by employees within the organization during a preceding live period (e.g., the preceding week, the preceding month); and leverage this email data to populate a local whitelist for a subsequent live period succeeding the setup period. Therefore, after the setup period and during the subsequent live period, the system can implement this local whitelist to verify authenticity of inbound emails received by employees during this live period.

### 4.1 Local Whitelist: Verified Senders

The computer system can identify a select group of verified senders of inbound emails within the organization who interact (e.g., via email) most frequently with employees within the organization. The system can then populate a local whitelist including email addresses of senders in the select group of verified senders. Later, the system can leverage this local whitelist to automatically release and/or transmit emails sent by senders included in the local whitelist. Therefore, the computer system can automatically authorize transmission of emails sent from email addresses included in the local whitelist without further checks for authenticity, thereby reducing overhead and computational power spent scanning these inbound emails for spoofing attempts.

4.1.1 Populating the Whitelist: Quantity of Emails Received from a Sender

In one implementation, the computer system can identify a select group of verified senders that send the highest quantity of emails to employees within the organization. The computer system can then populate a local whitelist including a set of email addresses associated with the select group of verified senders. In particular, in this implementation, the computer system can: initialize a local whitelist (e.g., an organization-specific whitelist); and access a corpus of inbound emails received by employees within the organization within a preceding time period (e.g., one week, one month, one year). Then, for each inbound email, in the corpus of inbound emails, the computer system can: identify an email address corresponding to a sender of the inbound email; access a sender email address list corresponding to the preceding time period; in response to the sender email address excluding the email address, append the sender email address with the email address; and, in response to identifying the email address in the sender email address list, update a count corresponding to a number of inbound emails sent by the email address in the preceding time period. The computer system can then: identify a select group of senders corresponding to a subset of email addresses, in the sender email address list, based on the count associated with each email address, in the sender email address list; and populate a local whitelist with email addresses of the select group of senders.

In one example, the system can populate the local whitelist with a fixed quantity of email addresses (e.g., 50 email addresses, 100 email addresses, 1000 email addresses) corresponding to verified senders who sent a highest quantity of inbound emails to employees within the preceding time period. In particular, in this example, the computer system can: access a corpus of emails received by recipients within the organization during an initial time period preceding the first time; for each email, in the corpus of emails, identify a sender email address, in a set of sender email addresses, corresponding to a sender of the email; for each sender email address, in the set of sender email addresses, derive a sender email count, in a set of sender email counts, representing a quantity of emails received from the sender email address, within the organization, during the initial time period; and, in response to a first subset of sender email counts, in the set of sender email counts, exceeding each other sender email count in the set of sender email counts, populating the whitelist with a first subset of sender email addresses, in the set of sender email addresses, corresponding to the first subset of sender email counts.

For example, the system can generate a sender email address list including: a set of unique email addresses corresponding to senders of inbound emails within the organization; and a set of counts, each count in the set of counts corresponding to a unique email address, in the set of unique email addresses, and representing a quantity of inbound emails sent from the unique email address. The system can then: sort the sender email address list according to count; select a subset of email addresses corresponding to the first 100 email addresses on the sender email address list; and populate the local whitelist with the subset of email addresses.

Additionally and/or alternatively, in another example, the system can populate the local whitelist with a fixed quantity of email addresses corresponding to a size of the organization. In particular, the system can automatically scale a size (e.g., a quantity of verified senders) of the local whitelist to automatically accommodate for organizations of various sizes (e.g., number of employees, number of inbound emails, number of clients) and/or outreach. For example, the system can populate: a first local whitelist including 1,000 verified senders for a larger organization, which may receive a higher quantity of inbound emails sent from a more diverse group of sender email addresses; and a second local whitelist including 100 verified senders for a smaller organization which may receive a lower quantity of inbound emails sent from a less diverse group of sender email addresses. In one example, the system can: access an employee count corresponding to a number of employees within an organization; calculate a square root of the employee count; and populate a local whitelist for the organization including a number of verified senders matched to the square root of the employee count.

Additionally and/or alternatively, in another example, the system can populate the local whitelist with email addresses corresponding to verified senders who sent at least a minimum number of inbound emails within the preceding time period. For example, the system can: access a corpus of inbound emails received by employees within the organization within the previous week; for a first inbound email, in the corpus of inbound emails, identify a first email address associated with a first sender of the first inbound email; compile a first subset of inbound emails, in the corpus of inbound emails, sent by the first email address associated with the first sender; and generate a count corresponding to a number of inbound emails in the first subset of inbound emails. Then, in response to the count exceeding a threshold count, the system can: label the first sender as a first verified sender; and populate a local whitelist with the first email address associated with the first verified sender.

### 4.1.2 Populating the Whitelist: Sender Engagement

Additionally and/or alternatively, in another implementation, the system can populate the whitelist based on engagement of senders of inbound emails within the organization. In particular, the system can characterize an engagement level (or “engagement score”) exhibited by each sender of inbound emails within the organization; and populate a local whitelist of email addresses corresponding to a group of verified senders exhibiting high levels of engagement (e.g., compared to other senders of inbound emails, above a minimum engagement level). In this implementation, the system can characterize engagement levels of senders of inbound emails based on inbound email metrics such as: a number of inbound emails sent from a particular sender; whether an employee responded to an inbound email; whether an employee read (or opened) an inbound email; whether an inbound email is within an email thread; whether an inbound email sent from a particular sender is a response to a previous email sent by an employee within the organization to the sender; etc.

For example, during a set-up period (e.g., each week, each month), prior to a live period, the system can: access a corpus of inbound emails received by employees within the organization within the previous week (or month, year, etc.); identify a first email address associated with a first sender of a first inbound email, in the corpus of inbound emails; and compile a first subset of inbound emails, in the corpus of inbound emails, sent by the first email address associated with the first sender. The system can then extract a set of email metrics from the first subset of inbound email, the set of email metrics including: a first quantity of inbound emails in the first subset of inbound emails (e.g., a total quantity of inbound emails sent from the first email address); a second quantity of opened inbound emails (e.g., based on read receipts of inbound emails in the first subset of inbound emails); a third quantity of outbound emails sent to the first email address in response to an inbound email, in the first subset of inbound emails; and a fourth quantity of reply inbound emails—such as in an email thread or in response to an outbound email sent (e.g., by an employee) to the first email address—in the first subset of inbound emails. The system can then characterize an engagement level of the first sender at the first email address—such as by calculating an engagement score for the first sender—based on this set of email metrics extracted from the first subset of inbound emails. Then, in this example, in response to the engagement level exceeding a threshold engagement level, the system can: label the first sender as a first verified sender; and populate a local whitelist, for the following live period, with the first email address corresponding to the first verified sender.

Alternatively, in the preceding example, the system can populate the whitelist with email addresses of senders who exhibit higher engagement than other senders. In particular, the system can: identify a sender email address, in a set of sender email addresses, corresponding to a sender of each email in the corpus of inbound emails received during the previous week; derive a sender email count, in a set of sender email counts, representing a quantity of emails received within the organization from each sender email address, in the set of sender email addresses, during the previous week; and, in response to a first subset of sender email counts, in the set of sender email counts, exceeding each other sender email count in the set of sender email counts, populate the whitelist with a subset of sender email addresses, in the set of sender email addresses, corresponding to the subset of sender email counts. The system can subsequently repeat this process the following week (and each week thereafter) to populate the whitelist with a new subset of sender email addresses—in replacement of the previously-identified subset of sender email addresses-corresponding to senders exhibiting the highest email engagement during the preceding week.

In this example, the system can therefore: characterize an engagement level for each sender of inbound emails, in the corpus of inbound emails received during the previous week; rank each sender, in a ranked list of inbound email senders, according to engagement level; identify a first subset of verified senders, from the ranked list of inbound email senders, corresponding to the highest ranked senders (e.g., the top 100 senders) in the ranked list; and populate a local whitelist, for the live period, with email addresses of verified senders in the first subset of verified senders.

### 4.1.3 Manually-Populated Whitelist

Additionally and/or alternatively, in one variation, the whitelist is generated manually and uploaded to the computer system via a web portal. For example, the computer system can autonomously generate an organization whitelist (e.g., a local whitelist) as described above. The computer system can then prompt an email administrator to manually enter additional approved sender email addresses (or sender domains) to add the autonomously generated organization whitelist. Additionally and/or alternatively, employees within the organization may access the web portal to manually enter additional approved sender email addresses.

### 4.2 Global Whitelist: Trusted Domains

In one variation, the computer system can generate and/or access a global whitelist including verified domains associated with trusted senders. For example, the computer system can populate a global whitelist including a trusted domain (e.g., Company ABCD with an email domain “@ABCD.com”). Therefore, the computer system can automatically authorize transmission of emails sent from email addresses including this particular domain without further checks for authenticity, thereby further reducing overhead and computational power spent scanning these inbound emails for content linked to spoofing attempts. In one implementation, this global whitelist can include domains linked to verified financial services—such as a bank, a credit card company, a payment processor—and/or other verified services (e.g., an email client, a communication platform) linked to the organization, which may be more likely to send emails containing content (e.g., finance and/or security related content) associated with spoofing attempts.

For example, during an initial setup period, the computer system can identify a set of financial institutions (e.g., a bank, a payment service) that interface with the organization, such as by prompting an email administrator to manually enter these financial institutions and/or by autonomously scanning a local server to identify the set of financial institutions. For each financial institution, in the set of financial institutions, the computer system can then: access a domain of email addresses for emails distributed by the financial institution; and populate a trusted domain whitelist with the domain. Therefore, because these financial institutions may be likely to send emails including content related to finance (e.g., invoices, requests for payment information or other sensitive information), the computer system can minimize latency and overhead in distributing emails sent by these financial institutions, associated with the organization, by automatically passing through emails sent from a trusted domain (e.g., on the trusted domain whitelist) without scanning these emails for content indicative of spoofing attempts.

### 4.3 Local and Global Blacklists: Untrusted Senders

In one variation, the computer system can generate (e.g., populate) a blacklist including untrusted email addresses from emails associated with past spoofing attempts and/or past fraudulent email attempts.

In particular, the blacklist can include: a set of flagged sender email addresses; a set of untrusted sender email domains; and/or a set of untrusted sender identifiers. Upon receiving an inbound email, the computer system can search the blacklist for a sender email address associated with the inbound email in Block S154 of the method S100 and, in response to the blacklist excluding the sender email address, proceed to an additional security check as described herein. Alternatively, in response to the inbound email passing additional security checks as described herein, the computer system can release the inbound email to the target recipient in response to the blacklist excluding the sender email address.

In one example, the computer system can, in response to receiving the first inbound email: access a blacklist associated with the organization and including a first set of flagged email addresses associated with fraudulent email attempts; and scan the first inbound email for presence of external content linked to the first inbound email in response to the first set of flagged email addresses omitting the first inbound email address. Additionally or alternatively, in response to the blacklist including the sender email address, the computer system can: automatically quarantine the inbound email; and/or alert security personnel of the inbound email (e.g., via a notification email).

In one example, the computer system can access a blacklist including: a first set of flagged email addresses associated with fraudulent email attempts within the organization; and a second set of flagged email addresses associated with global fraudulent email attempts. In particular, a first blacklist can represent an organization blacklist (e.g., a local blacklist) associated with the organization, and a second blacklist can represent a global blacklist of untrusted email addresses from senders associated with past fraudulent email attempts. In this example, the computer system can implement methods and techniques described herein to pass the inbound email to a following security check in response to the first blacklist and the second blacklist omitting the first sender email address and/or sender domain.

Therefore, in this variation, the computer system can automatically quarantine emails associated with blacklisted sender addresses without spending resources on additional security checks.

### 4.3.1 Populating Blacklists

In this variation, the computer system can populate the blacklist with known senders associated with fraudulent email attempts.

In one implementation, the computer system can populate a local blacklist, associated with an organization, with global blacklisted addresses (e.g., email addresses, email domains, phone numbers) associated with fraudulent email attempts.

In one example, in response to withholding transmission of a first inbound email to a target recipient, the computer system can update the blacklist (e.g., local blacklist, global blacklist) to include the first sender and the first inbound email address. In particular, in this example, the computer system can update a first (e.g., local) and/or second (e.g., global) set of flagged email addresses to include the first inbound email address.

Additionally or alternatively, in this variation, the blacklist is manually generated and uploaded to the computer system via a web portal. For example, the computer system can autonomously generate an organization blacklist (e.g., a local blacklist) as described above. The computer system can then prompt an email administrator to manually enter additional unapproved sender email addresses (or sender domains) to add the autonomously generated organization blacklist. Additionally or alternatively, employees within the organization may access the web portal to manually enter additional unapproved sender email addresses.

Accordingly, the computer system can dynamically update a local and/or global blacklist to include a particular email address in response to detecting fraudulent email attempts associated with the particular email address within the target organization.

### 5. INBOUND EMAIL CHECK

Generally, the computer system can receive (or “intercept”) inbound emails from senders and implement a series of security checks including: scanning the whitelist for sender email addresses; scanning the blacklist for sender email addresses; searching for presence of external documents linked to these inbound emails; searching for presence of malicious content within these external documents; and detecting language signals—associated with fraudulent email attempts—within these inbound emails.

In one implementation, once the whitelist is generated, the computer system can scan these inbound emails for language signals, such as keywords (e.g., “invoice,” “payment,” “transaction”, “urgent”) or content associated with spoofing attempts. The computer system can then verify the validity of inbound emails, including these keywords, prior to releasing these inbound emails to their designated recipients.

In particular, the computer system can: receive an inbound email from an inbound email address (hereinafter a “sender email address”); access a string of text contained in a body and/or subject line of the inbound email; access a keyword list including a set of keywords (e.g., including words and/or phrases) linked to spoofing attempts; compare the string of text to the set of keywords in the keyword list; and, in response to the string of text including one or many keywords, in the set of keywords, compare the sender email address to verified email addresses contained in the global and/or local whitelist.

For example, in response to receiving an inbound email from a sender at a sender email address defining a first domain, the inbound email designating a target recipient, the system can: access a keyword list including a set of keywords (e.g., words, phrases, and/or symbols) associated with spoofing attempts; extract a string of text included in a body and/or subject line of the inbound email; and, in response to the string of text excluding any keywords, in the set of keywords, deliver the inbound email to the target recipient. However, in this example, in response to the string of text including a first keyword, in the set of keywords, the system can: access a global whitelist including a set of verified domains; and extract a domain of the sender email address. Then, in response to the set of verified domains excluding the domain of the sender email address, the system can: access a local whitelist including a set of verified email addresses of verified senders for this organization; compare the sender email address to the set of verified email addresses; and, in response to the set of verified email addresses excluding the sender email address, quarantine the inbound email in a quarantine database and notify an email administrator of the inbound email for further investigation. Alternatively, in this example, if the set of verified domains includes the domain of the sender email address, the system can automatically deliver the inbound email to the target recipient. Similarly, if the set of verified email addresses includes the sender email address, the system can automatically deliver the inbound email to the target recipient.

Therefore, the system can deliver inbound emails: excluding content that may be linked to spoofing attempts; sent from sender email addresses including verified domains contained in the global whitelist; and sent from sender email addresses of verified senders included in the local whitelist generated for this organization. However, the system can withhold and/or flag inbound emails including content that may be linked to spoofing attempts and send from sender email addresses and/or email domains omitted from the global and/or local whitelists.

### 5.1 Language Signals

Generally, Blocks of the method S100 can be executed by the computer system to scan an inbound email for content indicating an invalid email attempt by scanning the inbound email for language signals (e.g., financial language signals, action language signals, urgency language signals). In particular, the computer system can implement language analysis models (e.g., natural language processing models, topic modeling and keyword extraction models, intent recognition models) to detect and flag words and/or phrases in a body of the email based on language signals in these words and/or phrases representing methods typical of phishing (and/or spoofing) attempts.

In one implementation, the computer system can execute a machine learning model on an inbound email to scan a body of the inbound email (and/or attachments linked to the inbound email) for language signals indicating a tone and/or a linguistic cue typical of phishing (and/or spoofing) attempts. In one example, the computer system can scan an inbound email and detect a first sequence of words (e.g., “You need to buy”), and calculate a correlation (e.g., 0.5, 0.76, 1) between the first sequence of words and a particular language signal (e.g., “need”, “to buy”), the correlation representing a similarity between the first sequence of words and the particular language signal and an indication of risk associated with the email (e.g., a “high” correlation representing a “high” risk) in Block S124.

In particular, the computer system can scan an inbound email for language signals including: urgency language signals; action language signals; financial language signals; and/or sensitive data signals.

In one implementation, the computer system can scan the body of the first inbound email for financial language signals in the set of language signals associated with fraudulent email attempts to access financial information associated with the organization. In this implementation, the computer system can detect language signals indicating a request for access to financial information associated with the recipient and/or the organization, such as a request for a purchase of a gift card, banking information, Social Security Number information, credit card information, etc. In this implementation, the computer system can calculate the first correlation between the first sequence of words, in the body of the first inbound email, with the first language signal in the set of language signals, the first language signal including a first financial language signal.

In another implementation, the computer system can scan the body of the first inbound email for urgency language signals and action language signals in the set of language signals associated with fraudulent email attempts and indicating urgency of actions requested in the body of the first inbound email. In this implementation, the computer system can detect language signals indicating an action the recipient may take, the action characterized by a particular urgency indicated by language signals in the email, such as “send me your phone number now”, “final notice”, “immediate action required”, “your account will expire”, “urgent”, etc. In this implementation, the computer system can, for a particular inbound email: calculate a first correlation between the first sequence of words, in the body of the first inbound email, with the first language signal in the set of language signals, the first language signal including a first urgency language signal; and calculate a second correlation between a second sequence of words, in the body of the first inbound email, with a second language signal in the set of language signals, the second language signal including a first action language signal.

In one variation, the computer system can calculate a set of correlations for an inbound email based on sequences of words within a body of the email and the set of language signals. In particular, the computer system can: detect a first correlation between a first sequence of words, in the body of the inbound email, with a first language signal in the set of language signals; detect a second correlation between a second sequence of words, in the body of the first inbound email, with a second language signal in the set of language signals; detect a third correlation between a third sequence of words, in the body of the inbound email, with a third language signal in the set of language signals; detect a fourth correlation between a fourth sequence of words, in the body of the first inbound email, with a fourth language signal in the set of language signals; and aggregate the first correlation, the second correlation, the third correlation, and the fourth correlation into a set of correlations. In this variation, in response to a subset of correlations (e.g., one, two) in the set of correlations exceeding the threshold correlation, the computer system can then: flag the inbound email as potentially fraudulent; quarantine the inbound email; and/or withhold transmission of the inbound email.

### 5.1.1 Keyword Check

In one variation, the computer system can scan an inbound email for content indicating an invalid email attempt by comparing words in a body of the inbound email (and/or in attachments linked to the inbound email) to a set of keywords (e.g., keyword list) established by an operator.

In this variation, upon receiving (or “intercepting”) an inbound email from a sender, the computer system can scan the contents of the inbound email to check for content associated with spoofing attempts. In particular, the computer system can compare contents of the email—such as words or combinations of words in a body or subject line of the inbound email—to a keyword list including words and/or combinations of words that are commonly included in inauthentic email attempts (i.e., spoofing attempts), such as “pay now,” “invoice,” “payment”, “fees,” “delinquent,” “account number,” “credit card,” “wire transfer,” etc. For example, the keyword list can include words, phrases, and/or symbols (e.g., “$”) that are associated with financial transactions; identity (e.g., “social security number,” “date of birth); security (e.g., “password,” “login credentials,” “update your password,” “code”); etc.

In one implementation, the keyword list can include multiple variations of a particular keyword. For example, the keyword list can include the keyword “invoice.” The system can, therefore, search each inbound email for the keyword “invoice” and further verify inbound emails containing this keyword. However, inauthentic email senders may attempt to avoid further verification of inauthentic emails by purposefully altering the word “invoice” in these inauthentic emails, such as by altering the letter “o” in “invoice” to the number “0” (i.e., zero) or misspelling the word “invoice” as “invioce.” The system can, therefore, include additional keywords resembling keywords contained in the keyword list. Similarly, the system can include keywords in various languages in the keyword list, such as based on a location of the organization and/or target recipient of an inbound email.

The system can therefore search the text of a body (e.g., content within the inbound email) and/or a subject line of an inbound email for these keywords contained in the keyword list to identify inbound emails which may be more likely to be inauthentic and/or which may be more likely to incite negative consequences (e.g., financial loss, identity theft, security breach) if inauthentic.

### 5.2 Language Signals+Risk

In one variation, the computer system can: calculate a risk score (e.g., “1 of 10”, “8 of 10”, “10 percent”, “80 percent”) for a particular inbound email in Block S126; and, in response to the risk score exceeding a threshold risk score, withhold transmission of (e.g., quarantine) the inbound email. Additionally or alternatively, the computer system can pass the inbound email to the target recipient in response to the risk score for the inbound email falling below a threshold risk score.

In one example, the computer system can calculate a risk score for a particular inbound email based on: a correlation between a word (or sequence of words) in a body of the inbound email and a first language signals in the set of language signals; and presence of an external document linked to the inbound email. In particular, in this example, in response to detecting a link to an external document within the inbound email, the computer system can: scan a body of the inbound email for language signals in the set of language signals associated with fraudulent email attempts; detect a correlation between a sequence of words, in the body of the inbound email, with a language signal in the set of language signals; calculate a risk score for the inbound email based on the correlation and (presence of) the external document; and, in response to the risk score for the inbound email falling below a threshold score, pass the inbound email to the recipient. Additionally or alternatively, the computer system can calculate a risk score for a particular inbound email based on the correlation and presence of malicious content in the external document.

In another example, the computer system can calculate a risk score for a particular inbound email based on a correlation between a word (or sequence of words) in a body of the email and a language signal in the set of language signals. In particular, in this example, the computer system can: scan a body of the inbound email for language signals in a set of language signals associated with fraudulent email attempts; calculate a first correlation between a sequence of words, in the body of the inbound email, with a first language signal in the set of language signals; in response to the first correlation exceeding a threshold correlation, calculate a first risk score for the first inbound email based on the first correlation; and, in response to the first risk score exceeding a threshold risk score, withhold transmission of the inbound email to the recipient.

In yet another example, the computer system can calculate a risk score based on a set of (e.g., multiple) correlations between words in a body of an email and language signals in the set of language signals. In particular, in this example, the computer system can: calculate a first correlation between a first sequence of words, in the body of the first inbound email, with a first language signal (e.g., an urgency language signal, an action language signal) in the set of language signals; calculate a second correlation between a second sequence of words, in the body of the first inbound email, with a second language signal (e.g., an action language signal, a financial language signal) in the set of language signals; and calculate a first risk score for the first inbound email based on the first correlation and the second correlation. In response to the first risk score falling below the threshold risk score, the computer system can pass the inbound email to the target recipient.

Accordingly, the computer system can calculate a risk score for a particular inbound email based on language signals, presence (or absence) of external documents, and/or presence (or absence) of malicious content within these external documents. Therefore, the computer system can enable release of verified inbound emails to target recipients within an organization in response to these verified emails representing a risk below a particular risk threshold, such as a risk threshold established by an operator associated with the organization and/or a global system operator.

### 5.2.1 Keywords+Risk

In one implementation, the system can leverage identification of words or phrases in an inbound email that are included in the keyword list to characterize risk associated with the inbound email. The system can then selectively withhold and/or authorize transmission of the inbound email based on risk associated with the inbound email. For example, in response to receiving a first inbound email, the system can scan text of the first inbound email-including a body and/or subject line of the first inbound email—for presence of a set of keywords in a keyword list. The system can then generate a first keyword count representing a total number of instances of each keyword, in the set of keywords, present in text of the first inbound email. Then, in response to the first keyword count falling below a threshold count (e.g., one keyword, two keywords, five keywords), the system can characterize the first inbound email as relatively low risk and authorize transmission of the first inbound email to a target recipient. Then, in response to receiving a second inbound email, the system can similarly: scan text of the second inbound email for presence of the set of keywords in the keyword list; and generate a second keyword count representing a total number of instances of each keyword, in the set of keywords, present in text of the second inbound email. Then, in response to the second keyword count exceeding the threshold count, the system can characterize this second inbound email as relatively high risk, withhold transmission of the second inbound email to a target recipient, and/or flag the second inbound email for further investigation (e.g., by an email administrator).

In another example, the system can assign different weights (or “risk values”) to different keywords in the keyword list and characterize risk associated with inbound emails accordingly. In particular, in this example, for a first inbound email addressed to a target recipient, in response to identifying a first keyword (e.g., “account”), in the keyword list, and a second keyword (e.g., “social security”), in the keyword list, within the text of the first inbound email, the system can: access a first risk value (e.g., “25 percent”, “0.25”, “low-to-moderate risk”) assigned to the first keyword; access a second risk value (e.g., “90 percent”, “0.9”, “high risk”) assigned to the second keyword; and characterize a first risk score for the first inbound email based on the first risk value and the second risk value. Then, in response to the first risk score exceeding a threshold risk (e.g., specified by the organization, a global threshold risk), the system can withhold transmission of the first inbound email to a specified target recipient and/or flag the first inbound email for further investigation. Additionally, for a second inbound email addressed to the target recipient, in response to identifying the first keyword and a third keyword (e.g., “receipt”), in the keyword list, within the text of the second inbound email, the system can: access the first risk value assigned to the first keyword; access a third risk value assigned to the third keyword and less than the second risk value assigned to the second keyword; and characterize a second risk score-less than the first risk score—for the second inbound email based on the first risk value and the third risk value. In response to the second risk score falling below the threshold risk, the system can authorize transmission of the second inbound email to the specified target recipient.

Additionally and/or alternatively, in another implementation, the system can automatically withhold transmission of an inbound email and/or flag the inbound email for further investigation in response to detecting presence of any single keyword in the keyword list within the inbound email.

### 5.3 Linked Content Detection

In one variation, the computer system can scan the contents of the inbound email to check for external content linked to the inbound email, such as a hyperlink—pointing to an external webpage—inserted in a body of the inbound email and/or a pdf attachment appended to the inbound email. In particular, the computer system can leverage detection of linked external content (e.g., a hyperlink, an email attachment) within an inbound email—which may be indicative of a spoofing attempt—to selectively authorize and/or withhold transmission of the inbound email to a target recipient.

The system can therefore search the inbound email for linked external content (or a “link”) that points to an electronic document—such as a webpage or a pdf document—external the inbound email to identify inbound emails that may be more likely to be inauthentic. For example, in response to receiving an inbound email received from a sender email address, the system can scan the inbound email for a downloadable email attachment linked to an external document and/or for a hyperlink that points to an external webpage. Then, in response to detecting presence of a particular link to external content, the system can query the whitelist to compare the sender email address associated with the inbound email to the set of verified email addresses in the whitelist. Alternatively, in this example, in response to detecting absence of a link to external content, the system can automatically authorize transmission of the inbound email to a target recipient.

Further, in one implementation, the system can leverage characteristics of a detected link to external content to characterize risk associated with the inbound email containing this detected link. For example, in response to detecting a hyperlink included in a body of an inbound email, the system can access a set of characteristics of the hyperlink, such as: an address (e.g., a URL) of a webpage corresponding to the hyperlink; a length (e.g., a quantity of characters) of the address; webpage metadata corresponding to the webpage; placement of the hyperlink within the inbound email; correlation between content of the inbound email and the hyperlink and/or a landing page associated with the hyperlink; etc. Then, based on these characteristics, the system can characterize risk associated with the inbound email. For example, the system can characterize risk based on a length of the address included in the hyperlink, which may be indicative of a spoofing attempt. In this example, for a first inbound email including a first hyperlink of a first length exceeding a threshold length, the system can calculate a first risk score—such as “20 percent” risk and/or “low” risk—representing risk associated with the first inbound email. Then, for a second inbound email including a second hyperlink of a second length less than the threshold length, the system can calculate a second risk score—such as “80 percent” risk and/or “high” risk—representing risk associated with the second inbound email, the second risk score exceeding the first risk score. Based on this risk score, the system can selectively authorize or withhold transmission of the inbound email.

In particular, in the preceding example, the system can: authorize transmission of the first inbound email corresponding to the first risk score in response to the first risk score falling below a threshold risk; and withhold transmission of the second inbound email corresponding to the second risk score in response to the second risk score exceeding the threshold risk.

### 5.3.1 Linked Content Scanning

In one variation, the computer system can: access the external document (e.g., attachment, webpage) linked to the inbound email; and scan the external document for presence of malicious content (e.g., a virus, spoofing language signals, corrupted data) indicative of a spoofing (or fraudulent) attempt in Block S132.

In one example, the computer system can: scan the first inbound email for presence of hyperlinks within the first inbound email; in response to detecting a first hyperlink to a first external document within the first inbound email, scan the first external document for presence of malicious content; and, in response to detecting malicious content in the first external document, withhold transmission of the first inbound email to the first recipient.

In particular, the computer system can investigate a hyperlink for presence of malicious content based on a redirect chain associated with the hyperlink, presence of hidden links in a page source associated with the hyperlink, and/or presence (or absence) of encryption (e.g., validated presence of “https://” within the link), etc.

In one variation, the computer system can implement methods and techniques described herein to: further investigate (e.g., scan) the external document for presence of a second external document; and, in response to detecting a second external document, scan the second external document for presence of malicious content. In this variation, the computer system can withhold transmission of the first inbound email to the first recipient in response to detecting malicious content in the second external document.

In another implementation, the computer system can: scan the first inbound email for presence of attachments; and, in response to detecting a first attachment linked to the first inbound email, scan the first attachment for presence of malicious content. In particular, the computer system can implement methods and techniques described herein to scan the attachment for language signals, in the set of language signals, indicating a spoofing and/or fraudulent email attempt. For example, in response to detecting a first attachment within the first inbound email, the computer system can: scan the first attachment for presence of malicious content; scan the first attachment for language signals in the set of language signals; and, in response to detecting a second language signal, in the set of language signals, in the first attachment, withhold transmission of the first inbound email to the first recipient.

In yet another implementation, the computer system can: scan the first inbound email for presence of audio files; and, in response to detecting a first audio file linked to the first inbound email, scan the first audio file and/or a transcription of the first audio file for presence of malicious content. In particular, the computer system can: scan the first inbound email for presence of audio files linked to the first inbound email in Block S130; detect a first audio file within the first inbound email in Block S134; transcribe the first audio file into a first transcription representing content from the first audio file in Block S135; and insert the first transcription into the body of the first inbound email in Block S136. The computer system can then, in response to inserting the first transcription into the body of the first inbound email, scan the body of the first inbound email, including the first transcription, for language signals in the set of language signals.

In a similar variation, the computer system can: intercept an audio message (e.g., phone call, voicemail, Voice over Internet Protocol or “VOIP”) from an originating address (e.g., phone number, VOIP number, shortcode, SIP address, internal extension code) in Block S112; transcribe content from the audio message into a body of an email; and implement methods and techniques described herein to scan the body of the email (or the transcription of the audio message) for language signals in the set of language signals, indicating a fraudulent contact attempt. In particular, in this variation, the computer system can: intercept a first inbound audio message received from a sender at an originating address and addressed to a target recipient associated with the organization; access a set of verified addresses (e.g., whitelist) associated with authentic audio message attempts within the organization; transcribe the first inbound audio message into a first audio message transcription (e.g., in response to the set of verified addresses omitting the originating address); insert the first audio message transcription into a body of an email designating the target recipient; scan the body of the email for language signals in the set of language signals associated with fraudulent email attempts; and, in response to detecting a correlation between a sequence of words in the body of the second email with a language signal in the set of language signals, withhold transmission of the email to the target recipient.

Accordingly, the computer system can implement methods and techniques described herein to: scan an inbound message (e.g., email, audio message, text message) for links to external documents (e.g., hyperlinks, attachments); and, in response to detecting a link to an external document, scan the external content for malicious content.

### 5.4 Keyword+Linked Content Check

In one variation, upon receiving an inbound email from a sender, the system can scan the contents of the inbound email for presence of high-risk content—or content associated with spoofing attempts—including both words or phrases included in the keyword list and/or linked external content (e.g., a hyperlink to an external webpage, a link to downloadable content, an email attachment) included within the inbound email. In this variation, the system can then selectively withhold the inbound email and/or flag the inbound email for further investigation based on detection of this high-risk content.

In one implementation, the system can selectively scan for linked external content within the inbound email based on identification of words or phrases included in the inbound email within the keyword list. In particular, in this implementation, the system can: intercept an inbound email received from a sender at an inbound email address and addressed to a target recipient within the organization; compare a set of words contained in the inbound email (e.g., in a body and/or subject line of the inbound email) to a set of keywords included in the keyword list; and, in response to identifying a first word, in the set of words contained in the inbound email, in the set of keywords, scan the inbound email for presence of linked external content—such as a hyperlink pointing to a webpage and/or an attached document—within the inbound email. Then, in response to detecting a link (e.g., a hyperlink, an icon representing a downloadable file) to an external electronic document (e.g., a webpage, a computer file) within the inbound email, the system can access and search the whitelist for the inbound email address. The system can then selectively withhold or authorize transmission of the inbound email based on whether the inbound email address—or a domain of the inbound email address—is included in the whitelist (e.g., the local and/or global whitelist). Additionally and/or alternatively, in a similar implementation, the system can selectively scan text of the inbound email for words or phrases contained in the keyword list based on detection of linked external content within the inbound email.

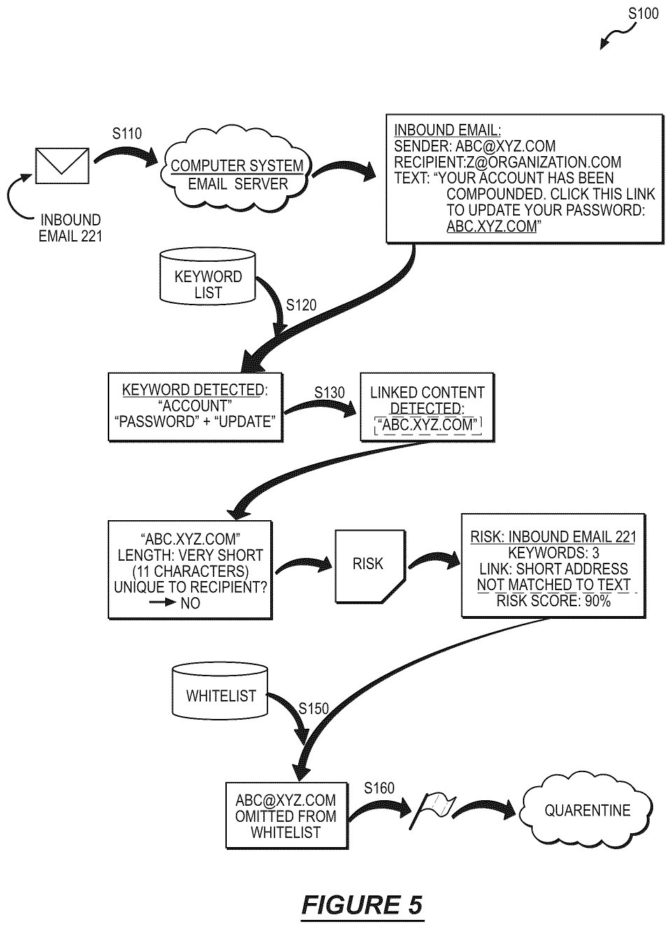

Additionally and/or alternatively, in another implementation, as shown in FIG. 5, the system can automatically scan the text of an inbound email for words or phrases contained in the keyword list and scan for presence of linked external content within the inbound email responsive to intercepting the inbound email. In particular, in this implementation, the system can: intercept an inbound email received from a sender at an inbound email address and addressed to a target recipient within the organization; compare a set of words contained in the inbound email (e.g., in a body and/or subject line of the inbound email) to a set of keywords included in the keyword list; scan the inbound email for presence of linked external content within the inbound email; and characterize risk associated with the inbound email based on presence and/or absence of words in the set of keywords and linked external content within the inbound email. The system can then selectively check the whitelist for the inbound email address—such as in response to characterizing the inbound email as relatively high risk—or automatically authorize transmission of the inbound email to the target recipient, such as in response to characterizing the inbound email as relatively low risk.

For example, in response to intercepting an inbound email received from a sender at an inbound email address and addressed to a target recipient within an organization, the system can: access a keyword list including a set of keywords associated with inauthentic email attempts; compare a set of words contained in the inbound email to the set of keywords; and scan the inbound email for presence of linked external content within the inbound email. Then, in response to identifying a first word (e.g., “financial”, “invoice”, “password”, “account number”), in the set of words, in the set of keywords in the keyword list and, in response to detecting a hyperlink to a webpage included within a body of the inbound email, the system can characterize the inbound email as relatively high-risk—based on presence of a keyword(s) and linked external content within the inbound email—and search the whitelist for the inbound email address in a set of verified email addresses contained in the whitelist. Then, in response to the set of verified email addresses omitting the inbound email address, the system can withhold transmission of the inbound email for further investigation. Alternatively in response to the set of verified email addresses including the inbound email address, the system can authorize transmission of the inbound email to the target recipient.

Alternatively, in the preceding example, in response to the set of keywords in the keyword list omitting each word in the set of words contained in the inbound email, and in response to detecting absence of external content linked to the inbound email, the system can characterize the inbound email as relatively low-risk—based on absence of any keywords or linked external content within the inbound email—and automatically authorize transmission of the inbound email to the target recipient, such as without scanning the whitelist for the inbound email address.

Alternatively, in the preceding example, in response to identifying the first word, in the set of words contained in text in the inbound email, in the set of keywords in the keyword list, and in response to detecting absence of linked external content within the inbound email, the system can characterize risk associated with the inbound email based on presence of the first word—and/or other keywords included in the keyword list—and absence of linked external content within the inbound email.

For example, in response to identifying a first subset of words contained in the inbound email in the set of keywords in the keyword list, the system can: access a first subset of risk values assigned to the first subset of words; calculate a keyword score based on the first subset of risk values; assign a linked content score of null based on absence of linked content within the inbound email; and calculate a risk score for the inbound email based on a combination of the first keyword score and the first linked content score. Then, in response to the risk score falling below a threshold risk, the system can automatically authorize transmission of the inbound email to a corresponding target recipient. Alternatively, in response to the risk score exceeding the threshold risk, the system can access the global and/or local whitelist to check for inclusion of the inbound email address within these whitelists accordingly. In a similar example, in response to the set of keywords omitting each word, in the set of words contained in the inbound email, and in response to detecting presence of the hyperlink within the inbound email, the system can characterize risk associated with the inbound email based on absence of keywords in the keyword list and presence of the hyperlink in the inbound email.

### 5.5 Whitelist Check

The system can access the global whitelist and/or local whitelist to compare an inbound email address—corresponding to a sender of an inbound email—to the set of verified domains and/or set of verified email addresses included in these whitelists. In response to identifying the inbound email address in the set of verified domains and/or the set of verified email addresses, the system can automatically authorize transmission of the inbound email to a target recipient of the inbound email.

In one implementation, the system can query the whitelist—such as the global whitelist and/or the local whitelist—in response to detecting content associated with a spoofing attempt within the inbound email. For example, in response to receiving an inbound email—addressed to a target recipient within an organization—received from a sender at an inbound email address, the system can scan the inbound email for content related to spoofing attempts, such as by comparing text of the inbound email to a keyword list and/or by scanning the inbound email for external content (e.g., a hyperlink, an attachment) linked to the inbound email, as described above. Then, in response to detecting presence of content related to a spoofing attempt—such as by detecting presence of a keyword in the keyword list and/or by detecting a hyperlink included in a body of the inbound email—the system can: access a global whitelist including a set of verified domains associated with authentic email attempts; compare a domain of the inbound email address to the set of verified domains in the global whitelist; and, in response to identifying the domain in the set of verified domains, authorize transmission of the inbound email to the target recipient. Alternatively, in response to the set of verified domains omitting the domain of the inbound email address, the system can: access a local whitelist including a set of verified email addresses associated with authentic email attempts within the organization; compare the inbound email address to the set of verified email addresses in the local whitelist; and, in response to identifying the inbound email address in the set of verified email addresses, authorize transmission of the inbound email to the target recipient.

However, in response to the set of verified email addresses omitting the inbound email address—and in response to the set of verified domains omitting the domain—the system can withhold transmission of the inbound email to the target recipient and flag the inbound email for authentication (e.g., by an email administrator). Therefore, in this implementation, the system can minimize latency in email delivery by only checking the whitelist for a particular inbound email address if the inbound email includes content associated with a spoofing attempt.

Alternatively, in another implementation, the system can compare the inbound email address to the set of verified domains and/or the set of verified email addresses included in the global and/or local whitelists before scanning the inbound email for content—such as keywords and/or linked content (e.g., a hyperlink, an attachment) associated with a spoofing attempt.

For example, in response to receiving an inbound email—addressed to a target recipient within an organization—received from a sender at an inbound email address, the system can: access a global whitelist including a set of verified domains associated with authentic email attempts; compare a domain of the inbound email address to the set of verified domains in the global whitelist; and, in response to identifying the domain in the set of verified domains, authorize transmission of the inbound to the target recipient. Alternatively, in response to the set of verified domains omitting the domain of the inbound email address, the system can: access a local whitelist including a set of verified email addresses associated with authentic email attempts within the organization; compare the inbound email address to the set of verified email addresses in the local whitelist; and, in response to identifying the inbound email address in the set of verified email addresses, authorize transmission of the inbound email to the target recipient. However, in response to the set of verified email addresses omitting the inbound email address—and in response to the set of verified domains omitting the domain—the system can scan the inbound email for content related to spoofing attempts, such as by comparing text of the inbound email to a keyword list and/or by scanning the inbound email for external content (e.g., a hyperlink, an attachment) linked to the inbound email, as described above. The system can then selectively authorize and/or withhold transmission of the inbound email based on detection of these keywords and/or linked external content, as described above.

Therefore, in the preceding implementation, the system can automatically release an inbound email received from a verified sender (e.g., at a verified domain and/or at a verified email address) to a target recipient of the inbound email—without scanning for keywords and/or linked content within this email—thereby reducing latency between sending of the inbound email by the verified sender and receiving of the inbound email by the target recipient.

### 6. EMAIL QUARANTINE

The system can quarantine inbound emails—including keywords indicative of spoofing attempts and sent from unverified senders—for further investigation by an email administrator.

In one implementation, the computer system can deliver an email notification to an email administrator (e.g., associated with the organization) including a hyperlink that, when selected by the email administrator, automatically opens a web browser with access to a web portal and the quarantined email for investigation. The email administrator may investigate the quarantined email and determine whether the inbound email is legitimate. Upon receiving verification of the inbound email by the email administrator via the web portal, the computer system can deliver the email to a designated recipient. Alternatively, if the email administrator determines the inbound email is not authentic, the computer system can withhold the inbound email from the designated recipient.

In one variation, a particular sender email address may send out multiple emails to multiple recipients within an organization. In this variation, the computer system can combine these inbound emails into one notification to the email administrator. For example, in response to receiving multiple inbound emails-including keywords contained in the keyword list—from a particular sender at an email address not contained in the global or local whitelist, the computer system can: flag each inbound email sent from this sender for quarantine; merge these inbound emails into a single email notification; deliver the email notification to the email administrator; receive verification or denial of these inbound emails or a subset of these inbound emails from the email administrator; and distribute these inbound emails or withhold these inbound emails accordingly.

### 6.1 Quarantine Portal

The computer system can withhold flagged inbound emails for further investigation of email validity within an online portal (or “quarantine portal”) accessible by the email administrator. The email administrator may access an instance of the quarantine portal (e.g., via a native application operating on her mobile phone, at a webpage operating on her laptop computer) to view, sort, and/or verify authenticity of inbound emails flagged by the computer system.

Upon flagging an inbound email for authentication, the computer system can automatically add the inbound email to a quarantined email list viewable to the email administrator within the quarantine portal. The email administrator may access the quarantine portal to view the updated quarantined email list and select the email to view an inbound email address and an inbound display name associated with the email. The email administrator may then investigate authenticity and, upon determination of an authentic sender, transmit authentication of the email to the computer system (e.g., via selection of a corresponding “authenticate” hyperlink). Alternatively, upon determination of an inauthentic sender (e.g., a spoofing attempt), the email administrator may transmit confirmation of a spoofing attempt to the computer system (e.g., via selection of a corresponding “spoof attempt” hyperlink). In response to receiving authentication of the email from the email administrator, the computer system can authorize transmission of the email to a target recipient designated in the email. Alternatively, in response to receiving confirmation of an inauthentic sender, the computer system can withhold transmission of the email to the target recipient and/or discard the email.

### 6.2 Invalid Email/Spoofing Attempt Notification

The computer system may receive confirmation from the email administrator via the web portal that an inbound email from a particular email address is not verified, invalid, or a spoofing attempt. Upon receiving this confirmation, the computer system can withhold the email from its designated recipient and instead discard the email.

In one variation, the computer system can generate a notification detailing this spoof attempt for delivery to the target recipient of the discarded email. Additionally and/or alternatively, the computer system can generate a notification detailing this spoof attempt for delivery to an employee associated with the verified display name copied or imitated in the spoofing attempt by the email sender.

### 7. AUTHENTICATED EMAIL

Upon receiving verification of an email initially flagged for quarantine (not found in the whitelist) from the email administrator via the web portal, the computer system can deliver the email to the original recipient in Block S170. Alternatively, the computer system can notify the email administrator of the email flagged for quarantine, and the email administrator may manually forward the email to a target recipient upon verification of the sender or withhold the email if the sender is not verified.

In one variation, the computer system can include a verified notification to the recipient in the email to communicate to the recipient that the email is from a verified sender. For example, the computer system can: receive verification of the email from the email administrator via the web portal, add a tag (e.g., a notification) in the email indicating the email has been verified and the contents and sender are legitimate, and deliver the email to a designated recipient. Therefore, the computer system can increase confidence of the recipient that the sender and the contents contained in the email are legitimate. Thus, the computer system can leverage the ability to verify the identity of email senders to increase trust and confidence of both senders and recipients of emails, and therefore enable employees to engage with or act on contents contained in emails more efficiently.

### 8. VARIATION: ORDER OF OPERATIONS

Generally, the method S100 is described herein as being executed by a computer system to execute a sequence (e.g., in series, in parallel) of security checks for an inbound email in response to detecting absence of a sender email address on a whitelist and/or blacklist associated with an organization (e.g., an unknown sender) in order to identify the inbound email as secure. Additionally or alternatively, the computer system can vary an order of the sequence of security checks, such as based on available computational resources and/or attributes of an inbound email.

In one variation, the computer system can execute the sequence of security checks prior to scanning the whitelist and/or blacklist for presence of the sender email address.

In another variation, the computer system can execute the sequence of security checks for a particular inbound email in response to detecting a sender email address associated with the inbound email on a whitelist associated with the organization. In particular, in this variation, the computer system can implement additional security checks for inbound emails, even if the sender is a trusted sender, to ensure all inbound emails are verified and sent by a verified sender at the verified email address. For example, in this variation, the computer system can: intercept an inbound email received from a sender at an inbound email address and addressed to a target recipient associated with the organization. The computer system can then, in response to the set of verified email addresses including the second inbound email address: scan the second inbound email for presence of external content linked to the second inbound email; in response to detecting a second link to a second external document within the second inbound email, scan a second body of the second inbound email for language signals in the set of language signals associated with fraudulent email attempts; and, in response to detecting a second correlation between a second sequence of words, in the second body of the second inbound email, with a second language signal in the set of language signals, withhold transmission of the second inbound email to the second recipient.

In another variation, the computer system can withhold transmission of an inbound email based on absence of a sender address in the whitelist and presence of malicious content within an external document linked to the inbound email. In this example, the computer system can, in response to the set of verified email addresses omitting an inbound email address: scan the inbound email for presence of external content linked to the inbound email; in response to detecting a link to an external document within the inbound email, scan the external document for presence of malicious content; and, in response to detecting presence of malicious content in the external document, withhold transmission of the inbound email to the recipient.

In a similar variation, the computer system can pass a second inbound email to a recipient based on absence of a second sender address in the whitelist and a correlation between sequences of words in a body of the second email falling below a threshold correlation and/or absence of a correlation. In particular, in this variation, the computer system can, in response to the set of verified email addresses omitting the second inbound email address: scan the second inbound email for presence of external content linked to the second inbound email; scan a second body of the second inbound email for language signals in the set of language signals associated with fraudulent email attempts; and, in response to detecting absence of a second correlation between sequences of words in the second body of the second inbound email with language signals in the set of language signals, pass the second inbound email to the second recipient. Therefore, in this implementation, the computer system can verify and pass an inbound email to a target recipient within the organization based on absence of fraudulent language signals and absence of external links embedded within the email.

In another variation, the computer system can scan a particular inbound email for language signals in the set of language signals, detect correlations between words in a body of the inbound email with language signals in the set of language signals, and, in response to these correlations exceeding a threshold correlation, validate a sender of the inbound email, such as by verifying presence of a sender email address on an organization whitelist. Similarly, the computer system can calculate a risk score for the inbound email based on these correlations and, in response to the risk score exceeding a threshold risk score, validate a sender of the inbound email, such as by verifying presence of a sender email address on an organization whitelist.

In particular, in this example, the computer system can: intercept a first inbound email received from a first sender at a first inbound email address and addressed to a first recipient; scan a body of the first inbound email for language signals in a set of language signals; detect a first correlation between a first sequence of words, in the body of the first inbound email, with a first language signal in the set of language signals; detect a second correlation between a second sequence of words, in the body of the first inbound email, with a second language signal in the set of language signals; calculate a risk score based on the first correlation and the second correlation; in response to the risk score exceeding a threshold risk score, access a whitelist associated with the organization and including a set of verified email addresses associated with authentic email attempts within the organization; and, in response to the set of verified email addresses omitting the first inbound email address, withhold transmission of the first inbound email to the first recipient.

In this example, the computer system can further validate the inbound email. In particular, the computer system can implement methods and techniques described herein to: scan the first inbound email for presence of external content linked to the first inbound email; in response to detecting a first link to a first external document within the first inbound email, scan the first external document for presence of malicious content; and calculate the risk score for the first inbound email based on the first correlation, the second correlation, and presence of malicious content in the first external document.

Additionally or alternatively, in this variation, the computer system can, in response to detecting absence of correlations between sequences of words, in the second body of the second inbound email, with language signals in the set of language signals: scan the second inbound email for presence of external content linked to the second inbound email; and, in response to detecting absence of external content linked to the second inbound email, pass the second inbound email to the second recipient.

### 9. CONCLUSION

The systems and methods described herein can be embodied and/or implemented at least in part as a machine configured to receive a computer-readable medium storing computer-readable instructions. The instructions can be executed by computer-executable components integrated with the application, applet, host, server, network, website, communication service, communication interface, hardware/firmware/software elements of a user computer or mobile device, wristband, smartphone, or any suitable combination thereof. Other systems and methods of the embodiment can be embodied and/or implemented at least in part as a machine configured to receive a computer-readable medium storing computer-readable instructions. The instructions can be executed by computer-executable components integrated by computer-executable components integrated with apparatuses and networks of the type described above. The computer-readable medium can be stored on any suitable computer readable media such as RAMs, ROMs, flash memory, EEPROMs, optical devices (CD or DVD), hard drives, floppy drives, or any suitable device. The computer-executable component can be a processor but any suitable dedicated hardware device can (alternatively or additionally) execute the instructions.

As a person skilled in the art will recognize from the previous detailed description and from the figures and claims, modifications and changes can be made to the embodiments of the invention without departing from the scope of this invention as defined in the following claims.

I claim:

1. A method comprising:
intercepting a first inbound email received from a first sender at a first inbound email address and addressed to a first recipient associated with an organization;
accessing a whitelist associated with the organization and comprising a set of verified email addresses associated with authentic email attempts within the organization; and
in response to the set of verified email addresses omitting the first inbound email address:
scanning the first inbound email for presence of external content linked to the first inbound email; and
in response to detecting a first link to a first external document within the first inbound email:
scanning a body of the first inbound email for language signals, in a set of language signals, associated with fraudulent email attempts; and
in response to detecting a correlation between a first sequence of words, in the body of the first inbound email, with a first language signal in the set of language signals, withholding transmission of the first inbound email to the first recipient.

2. The method of claim 1:
further comprising accessing a blacklist associated with the organization and comprising a first set of flagged email addresses associated with fraudulent email attempts;
wherein scanning the first inbound email for presence of external content linked to the first inbound email comprises scanning the first inbound email for presence of external content linked to the first inbound email in response to the first set of flagged email addresses omitting the first inbound email address; and
further comprising, in response to withholding transmission of the first inbound email to the first recipient based on the correlation between the first sequence of words, in the body of the first inbound email, with the first language signal in the set of language signals, updating the blacklist to include the first sender and the first inbound email address.

3. The method of claim 1, further comprising:
intercepting a second inbound email received from a second sender at a second inbound email address and addressed to a second recipient associated with the organization; and
in response to the set of verified email addresses omitting the second inbound email address:
scanning the first inbound email for presence of hyperlinks within the second inbound email; and
in response to detecting a second link to a second external document within the first inbound email:
scanning the second external document for presence of malicious content; and
in response to detecting malicious content in the second external document, withholding transmission of the second inbound email to the second recipient.

4. The method of claim 3:
wherein scanning the second external document for presence of malicious content comprises:
scanning the second external document for presence of a third external document linked to the second external document; and
in response to detecting presence of the third external document, scanning the third external document for presence of malicious content; and
wherein withholding transmission of the second inbound email to the second recipient comprises withholding transmission of the second inbound email to the second recipient in response to detecting malicious content in the third external document.

5. The method of claim 1:
wherein scanning the first inbound email for presence of external content linked to the first inbound email comprises scanning the first inbound email for presence of attachments; and
further comprising, in response to detecting the first link to the first external document comprising a first attachment within the first inbound email:
scanning the first attachment for presence of malicious content;
scanning the first attachment for language signals in the set of language signals; and
in response to detecting a second language signal, in the set of language signals, in the first attachment, withholding transmission of the first inbound email to the first recipient.

6. The method of claim 1:
wherein scanning the first inbound email for presence of external content linked to the first inbound email comprises scanning the first inbound email for presence of audio files linked to the first inbound email;
further comprising:
detecting the first link to the first external document comprising a first audio file within the first inbound email;
transcribing the first audio file into a first transcription representing content from the first audio file; and
inserting the first transcription into the body of the first inbound email; and
wherein scanning the body of the first inbound email for language signals in the set of language signals comprises scanning the body of the first inbound email for language signals in the set of language signals in response to inserting the first transcription into the body of the first inbound email.

7. The method of claim 1, further comprising:
intercepting a first inbound audio message received from a second sender at a first originating address and addressed to a second recipient associated with the organization;
accessing a set of verified addresses associated with authentic audio message attempts within the organization; and
in response to the set of verified addresses omitting the first originating address:
transcribing the first inbound audio message into a first audio message transcription;
inserting the first audio message transcription into a second body of a second email designating the second recipient;
scanning the second body of the second email for language signals in the set of language signals associated with fraudulent email attempts; and
in response to detecting a second correlation between a second sequence of words, in the second body of the second email, with a second language signal in the set of language signals, withholding transmission of the second email to the second recipient.

8. The method of claim 1, further comprising:
intercepting a second inbound email received from a second sender at a second inbound email address and addressed to a second recipient; and
in response to the set of verified email addresses including the second inbound email address:
scanning the second inbound email for presence of external content linked to the second inbound email; and
in response to detecting a second link to a second external document within the second inbound email:
scanning a second body of the second inbound email for language signals in the set of language signals associated with fraudulent email attempts; and
in response to detecting a second correlation between a second sequence of words, in the second body of the second inbound email, with a second language signal in the set of language signals, withholding transmission of the second inbound email to the second recipient.

9. The method of claim 1:
wherein withholding transmission of the first inbound email to the first recipient in response to detecting the correlation between the first sequence of words with the first language signal further comprises, in response to detecting the correlation between the first sequence of words with the first language signal:
calculating a first risk score for the first inbound email based on the correlation and the first external document; and
in response to the first risk score for the first inbound email exceeding a threshold score, withholding transmission of the first inbound email to the first recipient; and
further comprising:
intercepting a second inbound email received from a second sender at a second inbound email address and addressed to a second recipient; and
in response to the set of verified email addresses omitting the second inbound email address:
scanning the second inbound email for presence of external content linked to the second inbound email; and
in response to detecting a second link to a second external document within the second inbound email:
scanning a second body of the second inbound email for language signals in the set of language signals associated with fraudulent email attempts;
detecting a second correlation between a second sequence of words, in the second body of the second inbound email, with a second language signal in the set of language signals,
calculating a second risk score for the second inbound email based on the second correlation and the second external document; and
in response to the second risk score for the second inbound email falling below the threshold score, passing the second inbound email to the second recipient.

10. The method of claim 1, further comprising:
intercepting a second inbound email received from a second sender at a second inbound email address and addressed to a second recipient; and
in response to the set of verified email addresses omitting the second inbound email address:
scanning the second inbound email for presence of external content linked to the second inbound email; and
in response to detecting a second link to a second external document within the second inbound email:
scanning the second external document for presence of malicious content; and
in response to detecting presence of malicious content in the second external document, withholding transmission of the second inbound email to the second recipient.

11. The method of claim 1, further comprising
intercepting a second inbound email received from a second sender at a second inbound email address and addressed to a second recipient; and
in response to the set of verified email addresses omitting the second inbound email address:
scanning the second inbound email for presence of external content linked to the second inbound email; and
in response to detecting a second link within the second inbound email:
scanning a second body of the second inbound email for language signals in the set of language signals associated with fraudulent email attempts; and
in response to detecting absence of a second correlation between sequences of words in the second body of the second inbound email with language signals in the set of language signals, passing the second inbound email to the second recipient.

12. A method comprising:
intercepting a first inbound email received from a first sender at a first inbound email address and addressed to a first recipient;
accessing a whitelist associated with the organization and comprising a set of verified email addresses associated with authentic email attempts within the organization;
in response to the set of verified email addresses omitting the first inbound email address, accessing a blacklist associated with the organization and comprising a set of flagged email addresses associated with inauthentic email attempts; and
in response to the set of flagged email addresses omitting the first inbound email address:
scanning a body of the first inbound email for language signals in a set of language signals associated with fraudulent email attempts;
detecting a first correlation between a first sequence of words, in the body of the first inbound email, with a first language signal in the set of language signals;
in response to the first correlation exceeding a threshold correlation, calculating a first risk score for the first inbound email based on the first correlation; and
in response to the first risk score exceeding a threshold risk score, withholding transmission of the first inbound email to the first recipient.

13. The method of claim 12:
wherein scanning the body of the first inbound email for language signals in the set of language signals associated with fraudulent email attempts comprises:
scanning the body of the first inbound email for financial language signals in the set of language signals associated with fraudulent email attempts to access financial information associated with the organization; and
wherein detecting the first correlation between the first sequence of words, in the body of the first inbound email, with the first language signal in the set of language signals comprises:
detecting the first correlation between the first sequence of words, in the body of the first inbound email, with the first language signal in the set of language signals, the first language signal comprising a first financial language signal.

14. The method of claim 12:
wherein scanning the body of the first inbound email for language signals in the set of language signals associated with fraudulent email attempts comprises:
scanning the body of the first inbound email for urgency language signals and action language signals in the set of language signals associated with fraudulent email attempts and indicating urgency of actions requested in the body of the first inbound email;
wherein detecting the first correlation between the first sequence of words, in the body of the first inbound email, with the first language signal in the set of language signals comprises:
detecting the first correlation between the first sequence of words, in the body of the first inbound email, with the first language signal in the set of language signals, the first language signal comprising a first urgency language signal;
further comprising detecting a second correlation between a second sequence of words, in the body of the first inbound email, with a second language signal in the set of language signals, the second language signal comprising a first action language signal; and
wherein calculating the first risk score for the first inbound email comprises:
calculating the first risk score for the first inbound email based on the first correlation and the second correlation.

15. The method of claim 12:
further comprising:
scanning the first inbound email for presence of external content linked to the first inbound email; and
in response to detecting a first link to a first external document within the first inbound email, scanning the first external document for presence of malicious content; and
wherein calculating the first risk score for the first inbound email comprises calculating the first risk score for the first inbound email based on:
the first correlation; and
presence of malicious content in the first external document.

16. A method comprising:
intercepting a first inbound email received from a first sender at a first inbound email address and addressed to a first recipient;
scanning a body of the first inbound email for language signals in a set of language signals;
detecting a first correlation between a first sequence of words, in the body of the first inbound email, with a first language signal in the set of language signals;
detecting a second correlation between a second sequence of words, in the body of the first inbound email, with a second language signal in the set of language signals;
calculating a risk score based on the first correlation and the second correlation; and
in response to the risk score exceeding a threshold risk score:
accessing a whitelist associated with the organization and comprising a set of verified email addresses associated with authentic email attempts within the organization; and
in response to the set of verified email addresses omitting the first inbound email address, withholding transmission of the first inbound email to the first recipient.

17. The method of claim 16, further comprising:
intercepting a second inbound email received from a second sender at a second inbound email address and addressed to a second recipient;
scanning a second body of the second inbound email for language signals in the set of language signals;
detecting a third correlation between a third sequence of words, in the second body of the second inbound email, with a third language signal in the set of language signals:
detecting a fourth correlation between a fourth sequence of words, in the body of the first inbound email, with a fourth language signal in the set of language signals;
calculating a second risk score based on the third correlation and the fourth correlation; and
in response to the second risk score falling below the threshold risk score, releasing the second inbound email to the second recipient.

18. The method of claim 16:
further comprising:
scanning the first inbound email for presence of external content linked to the first inbound email; and
in response to detecting a first link to a first external document within the first inbound email, scanning the first external document for presence of malicious content; and
wherein calculating the risk score for the first inbound email comprises calculating the risk score for the first inbound email based on:
the first correlation;
the second correlation; and
presence of malicious content in the first external document.

19. The method of claim 16, further comprising:
intercepting a second inbound email received from a second sender at a second inbound email address and addressed to a second recipient;
scanning a second body of the second inbound email for language signals in the set of language signals;
detecting a third correlation between a third sequence of words, in the second body of the second inbound email, with a third language signal in the set of language signals;
calculating a second risk score based on the third correlation and the fourth correlation; and
in response to the second risk score exceeding the threshold risk score:
accessing the whitelist associated with the organization; and
in response to identifying the second inbound email address in the set of verified email addresses on the whitelist, releasing the second inbound email to the second recipient.

20. The method of claim 16, further comprising:
intercepting a second inbound email received from a second sender at a second inbound email address and addressed to a second recipient;
scanning a second body of the second inbound email for language signals in the set of language signals; and
in response to detecting absence of correlations between sequences of words, in the second body of the second inbound email, with language signals in the set of language signals:
scanning the second inbound email for presence of external content linked to the second inbound email; and
in response to detecting absence of external content linked to the second inbound email, passing the second inbound email to the second recipient.
